(19) United States
(12) Patent Application Publication
(10) Pub. No.: US 2018/0124468 A1
(43) Pub. Date: May 3, 2018

(54) METHOD AND DEVICE FOR ACCESSING TV SERVICE

(71) Applicant: TELEFONAKTIEBOLAGET LM ERICSSON (PUBL), Stockholm (SE)

(72) Inventor: Rathe HOLLINGUM, Dublin (IE)

(21) Appl. No.: 15/315,062

(22) PCT Filed: Jul. 10, 2014
(86) PCT No.: PCT/EP2014/064849

§ 371 Date: Nov. 30, 2016

(30) Foreign Application Priority Data
Jun. 4, 2014 (EP) PCT/EP2014/061624

(51) Int. Cl. H04N 21/482; H04N 21/422; G06F 3/0485; G06F 3/0484

(52) U.S. Cl. CPC H04N 21/4821; H04N 21/42208; G06F 3/04847; G06F 3/04855; H04N 21/42224

(57) ABSTRACT

A method of navigating on a time bar displayed on a screen of an electronic device where a position of a slider on said time bar is indicative of time of day. The method comprises determining a value indicative of interaction between a user and a user interface and changing the time indicated by the slider, wherein the change of time is in a non-linear relationship to the determined value. Various embodiments of devices implementing the above method are also disclosed.

### TECHNICAL FIELD

The present invention relates to a method of navigating on a time bar displayed on a screen of a device and to a device for providing access to content by navigating on a time bar, in general, and in particular to a method and device for accessing TV services via an Electronic Program Guide.

### BACKGROUND

Over the last decades, the steady increase in the number of available television channels has caused users to be overwhelmed by the amount of available linear TV content. The term “linear TV” refers to a TV service in which the viewer has to watch a TV program at the particular time the program is broadcast and on the specific channel it is presented on. Sometimes the term “live TV” is used with reference to the above mentioned “linear TV”. This increase made it hard to find TV content that would be relevant to the user amongst huge number of programs broadcast simultaneously. In order to make it easier for the user to find and select a program amongst large number of programs broadcast at the same time an Electronic Program Guide is delivered to a TV device as part of a TV service. The Electronic Program Guide (EPG) contains scheduling information for current and future TV programs. The EPG, in addition to scheduling information, often provides functions of a user interface that allows for interacting with the TV service. A user may, for example, select a program currently broadcast and after acknowledging the selection this program is displayed on the screen. The user may also select a future program and if such selection is acknowledged, then, depending on the TV device, the user may be given one or more of the following options: a reminder to switch to the selected program, automatic switching to the selected program or recording the selected program.

In the present implementations of the EPG navigation in time to find and select a program is realised in the form of a time bar with a slider indicating time of day and displaying information about TV programs broadcast (or to be broadcast in the future) at the time corresponding to the position of the slider on the time bar.

### SUMMARY

It is the object of the present invention to provide a solution that improves user experience when navigating on a time bar displayed on a screen.

According to a first aspect of the present invention there is provided a method of navigating on a time bar displayed on a screen of an electronic device where a position of a slider on said time bar is indicative of time of day. The method comprises determining a value indicative of interaction between a user and a part of a user interface for control of the slider and changing the time indicated by the slider, wherein the change of time is in a non-linear relationship to the determined value.

According to a second aspect of the present invention there is provided an electronic device comprising a screen operative to display a time bar where a position of a slider on said time bar is indicative of time of day. The electronic device also comprises a user interface for control of the slider. The electronic device further comprises a processor and a memory. Said memory contains instructions executable by said processor whereby said electronic device is operative to determine a value indicative of interaction between a user and a part of a user interface for control of the slider and to change the time indicated by the slider, wherein the change of time is in a non-linear relationship to the determined value.

According to a third aspect of the present invention there is provided an electronic device comprising a screen operative to display a time bar where a position of a slider on said time bar is indicative of time of day and a user interface for control of the slider. The electronic device further comprises an input control module operative to determine a value indicative of interaction between a user and a part of a user interface for control of the slider and an output control module operative to change the time indicated by the slider, wherein the change of time is in a non-linear relationship to the determined value

According to a fourth aspect of the present invention there is provided a TV set comprising a TV unit and a remote control device. The TV unit comprises a screen operative to display a time bar where a position of a slider on said time bar is indicative of time of day. The remote control device is configured to control said TV unit and said remote control device comprises: a user interface operative to control the slider, an input control module operative to determine a value indicative of interaction between a user and a part of the user interface for control of the slider and a wireless transmitter module operative to transmit to the TV unit the determined value. The TV unit further comprises a wireless receiver operative to receive the determined value from the remote control device and an output control module operative to change the time indicated by the slider, wherein the change of time is in a non-linear relationship to the determined value.

Moreover, there are also disclosed the following method and devices in various embodiments of the present invention.

A method of navigating on a time bar displayed on a screen of an electronic device where a position of a slider on said time bar is indicative of time of day comprises detecting an object in contact with a touch-sensitive user interface for control of the slider and determining speed at which the object moves along the touch-sensitive user interface. If the speed is at or below a first threshold then the method comprises moving the slider by a distance which is a first fraction of the distance travelled by the object along the touch-sensitive user interface.

An electronic device comprises a screen operative to display a time bar where a position of a slider on said time bar is indicative of time of day. The electronic device also comprises a touch-sensitive user interface for control of the slider, a processor and a memory. Said memory contains instructions executable by said processor whereby said electronic device is operative to detect an object in contact with the touch-sensitive user interface and determine speed at which the object moves along the touch-sensitive user interface. If the speed is at or below a first threshold then the electronic device is operative to move the slider by a distance which is a first fraction of the distance travelled by the object along the touch-sensitive user interface.

An electronic device comprising a screen operative to display a time bar where a position of a slider on said time bar is indicative of time of day. The electronic device also comprises a touch-sensitive user interface for control of the slider, an input control module and an output control module. The input control module is operative to detect an object in contact with the touch-sensitive user interface and to determine speed at which the object moves along the touch-sensitive user interface. The output control module is operative to move the slider by a distance which is a first fraction of the distance travelled by the object along the touch-sensitive user interface if the speed is at or below a first threshold.

A TV set comprising a TV unit and a remote control device. The TV unit comprises a screen operative to display a time bar where a position of a slider on said time bar is indicative of time of day. The remote control device is configured to control said TV unit. Said remote control device comprises a touch-sensitive user interface for control of the slider, an input control module operative to detect an object in contact with the touch-sensitive user interface and to determine speed at which the object moves along the touch-sensitive user interface. The remote control device further comprises a wireless transmitter module for transmitting to the TV unit data indicative of position of the object with reference to the touch-sensitive user interface and the determined speed. The TV unit further comprises a wireless receiver for receiving the data from the remote control device and an output control module operative to move the slider by a distance which is a first fraction of the distance travelled by the object along the touch-sensitive user interface if the speed is at or below a first threshold.

Further features of the present invention are as claimed in the dependent claims.

The present invention provides the benefit of improved precision in navigating on the time bar. Users can select on one page one day from a plurality of days, quickly move to a specific day and then easily and precisely change the time within this day in order to find the desired program.

### BRIEF DESCRIPTION OF THE DRAWINGS

The present invention will be understood and appreciated more fully from the following detailed description taken in conjunction with the drawings in which:

FIG. 1-FIG. 3 present flowcharts illustrating a method of navigating on a time bar displayed on a screen in various embodiments of the present invention;

FIG. 4 is a diagram illustrating an Electronic Program Guide displayed on a screen of a device in one embodiment of the present invention;

FIG. 5-FIG. 10 present block diagrams illustrating devices in various embodiments of the present invention;

FIG. 11 presents flowchart illustrating a method of navigating on a time bar displayed on a screen in one embodiment of the present invention;

FIG. 12-FIG. 15 present block diagrams illustrating devices in various embodiments of the present invention.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary details.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

The problem with navigating on a time bar displayed on a screen will be explained with reference to an example of a TV service displayed on a device with a touchscreen, for example a tablet. The TV service in this example is an Internet Protocol TV, but the way the TV service is delivered is not important for the present invention. In this example a user navigates on the time bar displayed on the screen by touching the touchscreen and dragging the slider on the time bar to a desired position. In order to give the user the freedom of broad selection the time bar should cover as many days as possible. However, the more days are shown on the time bar the less space is allocated to a single day. This leads to a situation that it is easy to navigate between days, but very difficult to navigate within a specific day. The number of pixels available for each day is small and a short move of the slider results in substantial change of time. For example, if we would like 1 pixel on the screen to represent 1 minute then for a single day we would need 1440 pixels. Of course, for the comfort of a user it is good to show not just one day but a whole sequence of days, for example a week. The resolution of a screen is fixed and for a Full High Definition screen it is 1920 pixels horizontally. However, there are many devices on the market with horizontal resolution lower than the Full HD, for example 1280 pixels or 1024 pixels. Clearly there are not enough pixels to show multiple days and keep very fine time resolution within an individual day. It is desired to show as many days in the time bar as possible because a click or a tap on any of the days should result in a fast navigation to that day.

In one example when on the screen there are 1008 pixels allocated for the time bar it is possible to show seven days with a pixel width of a single day equal 144 pixels. However when a user moves the slider on the the time bar he would have to drag the slider in 10 minutes intervals because in this example a single pixel on the time bar width corresponds to 10 minutes. Dragging the time in 10 minutes intervals is not acceptable in some cases and can break the now/next guide in cases where a show lasts only 5 minutes.

The invention in its embodiments introduces a non-linear relationship between the speed of the drag of the finger on the touchscreen and the change of time the slider indicates (or in preferred embodiments the speed the slider moves on the time bar). For example, the invention allows the user to perform a slow drag of the finger on a touch-sensitive user interface (e.g. touchscreen), which results in the slider on the time bar moving at a slower rate then the user drags the finger (e.g. when measured in pixels per unit of time). For example, if the user drags slowly the finger on the touchscreen then moving the finger by 4 pixels results in moving the slider on the time bar by only 2 pixels. The speed of the drag is considered slow if it is at or below a defined threshold.

If the speed of the finger along the touchscreen is above the threshold then moving the finger by 4 pixels results in moving the slider on the time bar by 4 pixels.

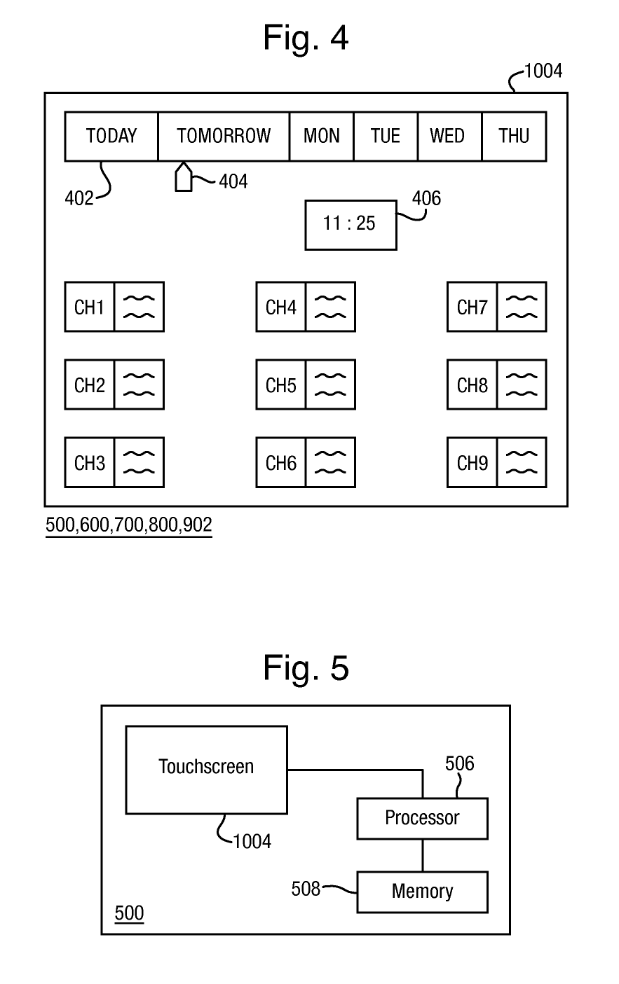

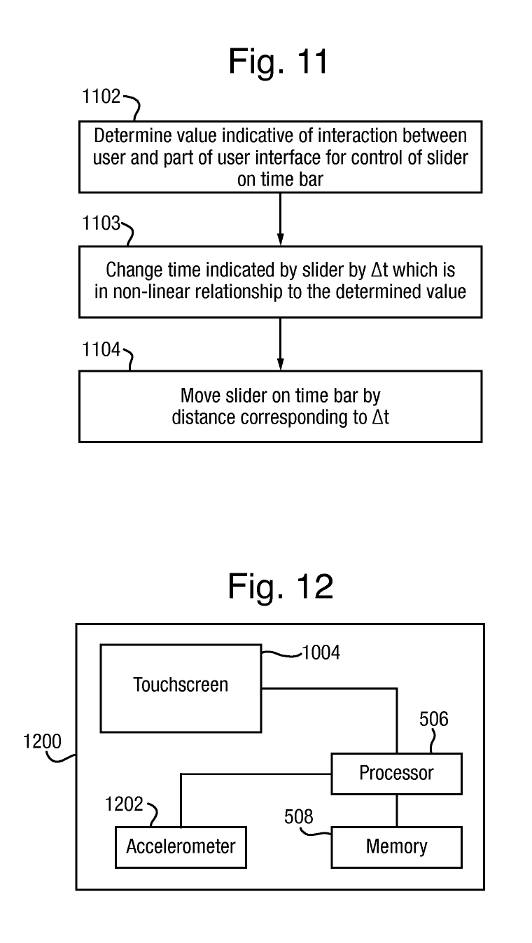

With reference to FIGS. 11 and 4 a method of navigating on a time bar displayed on a screen of an electronic device is disclosed in one embodiment of the present invention. On the time bar 402, which in a preferred embodiment may be a time bar of an electronic program guide of a TV service, a position of a slider is indicative of time of day and the method comprises determining 1102 a value indicative of interaction between a user and a part of a user interface for control of the slider. The interaction may take different form in different embodiments depending on the type of the user interface and some of these embodiments will be described below. Once the value is determined the method comprises changing 1103 the time indicated by the slider, wherein the change of time (Δt) is in a non-linear relationship to the determined value.

Preferably the method comprises moving 1104 the slider on the time bar by a distance corresponding to the change of time. For example, if one pixel corresponds to 10 minutes then change of time by 10 minutes results in moving the slider 404 by one pixel on the time bar 402. However, if the change of time is 5 minutes then the slider does not move, only the time indicated by the slider and displayed 406 on the screen 1004 is changed by 5 minutes. If the change of time is 25 minutes then the slider moves by two pixels because it is not possible to move an object on the screen by ½ pixel, but the time displayed 406 on the screen is updated according to the determined change of time Δt.

In one embodiment the step of determining, 1102, the value indicative of interaction between a user and a part of a user interface for control of the slider comprises determining acceleration of a device with the user interface caused by tilting said device with the user interface. As will be described in the following description the user interface, in some embodiments, may be integrated with the electronic device itself, for example in the case of a tablet or a smartphone. Alternatively, the device with the user interface is separate from the electronic device, but these two devices co-operate and are connected in some way, this can be for example a TV with a remote control or a game console with a controller connected to the console either via a cable or wirelessly. Game consoles these days allow for watching TV content as well and in many situations use time bars for navigation within shows. In the embodiment with determining acceleration caused by tilting the device with the user interface the angle of tilt may be the value used in determining the change of time Δt (or how much the slider 404 moves on the time bar 402).

In another alternative embodiment the step of determining 1102 comprises determining length of time the user presses a button controlling the slider on a device with the user interface. This embodiment can be implemented in a TV set with a remote control or in a game console with a controller where the control devices are usually equipped with buttons to control their main devices. In this embodiment the length of time the button is pressed may the value used in determining the change of time Δt (or how much the slider 404 moves on the time bar 402).

In yet another embodiment the step of determining 1102 comprises detecting an object in contact with a touch-sensitive user interface for control of the slider and determining speed at which the object moves along the touch-sensitive user interface. Although the term speed (scalar) is used throughout the specification it must be understood that the invention in its embodiments will also work when velocity (vector) is used. In determining the change of time Δt the scalar absolute value or magnitude of velocity (i.e. speed) is used and this is where the non-linear relationship is present, however the other vector characteristic of velocity i.e. direction of movement of the object in contact with the touch sensitive determines the direction of the change of time. Conventionally, moving the object in the left-to-right direction results in moving the slider 404 forward on the time bar 402. Conversely, moving the object in the right-to-left direction results in moving the slider 404 backward on the time bar 402. In other words, the Δt is a positive value for moving the slider forward and a negative value for moving in the opposite direction. This corresponds to pressing a left button (tilting to the left) in order to go backwards and pressing a right button (tilting to the right) in order to go forward.

The non-linear relationship between the determined value and the change of time indicated by the slider on the time bar may be defined using the formula below:

Δt=aX+bX² (1)

where a and b are values that may be determined in usability experiments depending on the various embodiments and X is the value determined in step 1102, e.g. speed, angle of tilt, time a button is pressed. In one embodiment the value a may be equal zero and b may be equal to one. In order to preserve the direction of change the value b may be negative when pressing a left button or tilting to the left, or moving the object in the right-to-left direction and positive when the opposite action is performed. Other, alternative formulas defining the non-linear relationships may be defined; one of them, using a threshold or thresholds is described in more details below. Of course in order to have Δt expressed in units of time the values a and b must be nominated depending on what is the unit of the value X. For example, if X is speed expressed in pixels/second then a is denominated in second/pixel and b is denominated in second³/pixel².

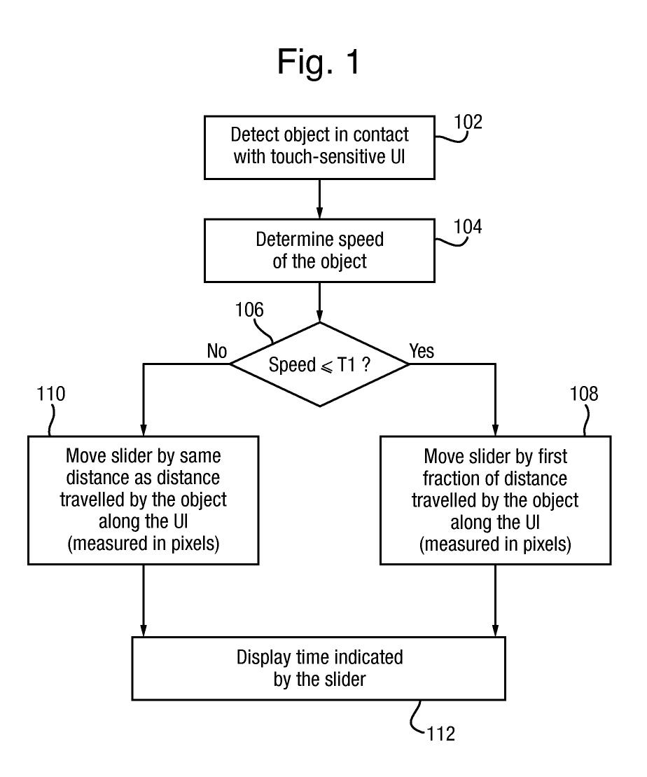

With reference to FIG. 1 and FIG. 4 a method of navigating on a time bar 402 displayed on a screen of an electronic device 500 is disclosed in another embodiment of the present invention. On the time bar 402, which in a preferred embodiment may be a time bar of an electronic program guide of a TV service, a position of a slider 404 on said time bar 402 is indicative of time of day. In a preferred embodiment the method comprises detecting 102 an object in contact with a touch-sensitive user interface for control of the slider 404. In known devices the touch-sensitive user interface can be realised in the form of a touchscreen (e.g. in tablets or some laptop computers) or in the form of a touchpad (e.g. in most laptop computers and some remote controls for TV sets).

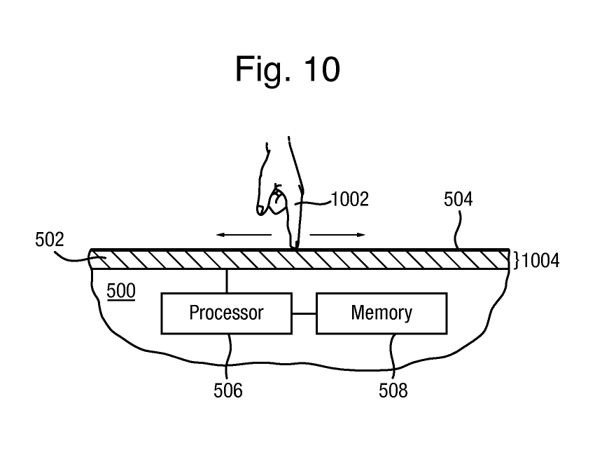

For simplicity and brevity in the following description a touchscreen will be used as an example of the touch-sensitive user interface, although it may well be, in alternative embodiments, a touchpad, and the user's finger will be used as an example of the object, although it is well known that instead of a finger a stylus may be used. FIG. 10 illustrates one example of a touchscreen 1004 that comprises a screen 502 for displaying still and motion pictures and a touch sensitive user interface 504. There are known different technologies that allows for practical realisations of touchscreens. Most popular are resistive and capacitive touchscreens and these are widely implemented in electronic devices. FIG. 10 does not illustrate any particular technology for making touchscreens, but rather depicts the concept of combining the functions of a display with the function of a touch-sensitive user interface. A user's finger 1002 is illustrated in contact with the touchscreen 1004 to control the position of the slider 404 on the time bar 402.

Once the contact of the finger 1002 with the touchscreen 1004 is detected the method comprises determining 104 speed at which the finger moves along the touchscreen. If the speed is at or below a first threshold 106 then the slider on the time bar is moved, 108, by a distance which is a first fraction of the distance travelled by the finger along the touchscreen. For example, if the speed is at or below the first threshold (T1) then the slider may move only half of the distance (measured in pixels) travelled by the finger on the touchscreen. In this way the slider will move slower than the finger, if the finger drags the slider slow enough so that the speed along the touchscreen is at or below the first threshold. The advantage of this solution is that it allows for very precise navigation on the time bar. For example, if the speed of the finger along the touchscreen is at or below the first threshold then moving the finger by 12 pixels on the touchscreen results in moving the slider by 6 pixels on the time bar 402. For the user's convenience, time of day corresponding to the position of the slider is displayed 112 on the touchscreen 1004. The method operates the same way when the touch-sensitive user interface and the screen are separate devices. In a preferred embodiment if the speed of the finger along the touchscreen is above the first threshold (T1) 106 then moving the finger results in moving the slider on the time bar by the same distance as the finger moved along the touchscreen measured in pixels 110. For example, moving the finger by 4 pixels results in moving the slider on the time bar by 4 pixels. Again, as explained earlier, for the user's convenience, time of day corresponding to the position of the slider is displayed 112 on the touchscreen 1004.

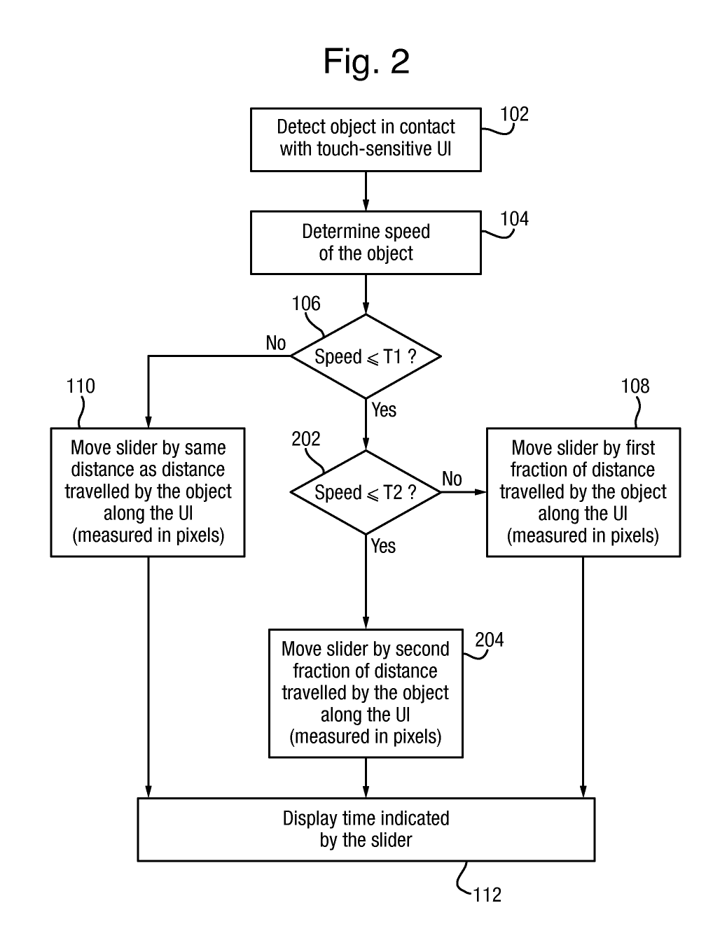

In one embodiment, illustrated in FIG. 2, the method introduces a second threshold (T2). After checking that the speed of the object along the touchscreen is at or below the first threshold (branch YES in step 106) the method comprises checking if the speed is at or below the second threshold 202. If the speed is at or below the second threshold (branch YES in step 202) the method comprises moving 204 the slider by a distance which is a second fraction of the distance travelled by the object. If, however, the speed is above the second threshold and at or below the first threshold the method comprises moving 108 the slider on the time bar by a distance which is a first fraction of the distance travelled by the finger along the touchscreen. Similarly to the embodiment illustrated in FIG. 1 if the speed of the finger along the touchscreen is above the first threshold (T1) (branch NO of the step 106) then moving the finger results in moving 110 the slider on the time bar by the same distance as the finger measured in pixels. As explained earlier, for the user's convenience, time of day corresponding to the position of the slider is displayed 112 on the touchscreen 1004, this is illustrated in FIG. 4 as element 406.

The advantage of this embodiment is that it allows for more adaptive navigation on the time bar with even increased precision. For example, if the speed of the finger along the touchscreen is at or below the second threshold then moving the finger by 12 pixels on the touchscreen results in moving the slider by 3 pixels on the time bar 402. The user may easily achieve a desired accuracy of navigation on the time bar by adjusting the speed he moves the finger on the touchscreen. Slowing down increases the accuracy and slowing down even further results in even better accuracy. The embodiment with two thresholds is especially beneficial for devices with low screen resolution and devices with small physical dimensions of the screen because, e.g. smartphones, because on a small screen even a short drag of a finger swipes through large number of pixels and it is difficult to move the slider very precisely. If the slider moves slower than the finger then precision will be increased. Having a threshold allows for effortless switching between coarse navigation between days to precise navigation within a single day by slowing down the drag.

In one embodiment the contact between the object, e.g. the finger or stylus, and the touch-sensitive user interface, e.g. the touchscreen or touchpad, is achieved when the object touches the touch-sensitive user interface. In alternative embodiment the contact between the object and the touch-sensitive user interface is achieved when the object is detected in proximity of the touch-sensitive user interface. There are known, although not yet widely implemented, solutions that allow for detecting a finger in proximity of the screen of an electronic device and tracking movements of the object (gestures) in order to control objects displayed on the screen or to control the device itself. These solutions are based on infrared sensors to detect a user's finger close to the screen without actually touching the screen. As the technology for realisation of the various user interfaces is known and is not the subject matter of the present invention no further details need to be discussed in this document.

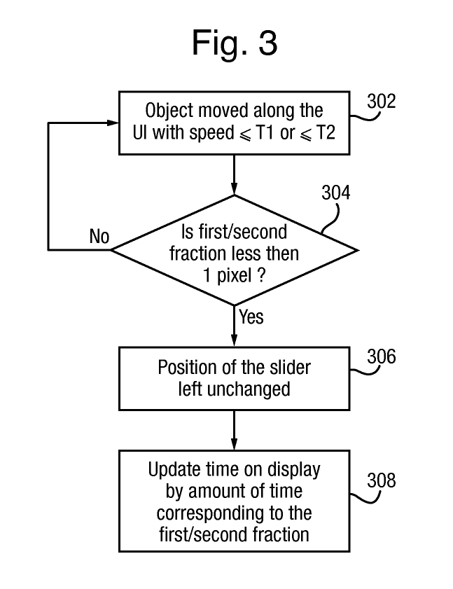

In one embodiment, illustrated in FIG. 3, if the first fraction of the distance travelled by the object along the touch-sensitive user interface is below 1 pixel 304 then position of the slider on the time bar is kept unchanged 306 and the method comprises updating 308 the time of day 406 displayed on the screen by an amount of time corresponding to the first fraction of the distance travelled by the object along the touch-sensitive user interface. In this embodiment the user finger moves 302 with a speed at or below the first threshold and if the distance travelled by the finger is short then the first fraction may be in some situations below 1 pixel. Of course it is not possible to move the slider by less than 1 pixel, but it is possible to calculate the change of time of day that corresponds to, for example, ½ pixel. In this embodiment the slider does not move, but the time of day displayed is updated by the value that corresponds to said ½ pixel. In this way if, for example, 1 pixel on the time bar corresponds to 10 minutes then it is possible to change the time of day indicated by the slider by 5 minutes and this has the great advantage that it is possible to find in the EPG short programs that last only 5 minutes. If the slider would be moved in 1 pixel intervals and the time of day would be updated in the corresponding 10 minute intervals these short TV programs would not show in EPG when the time bar spans over several days.

In another embodiment the method operates in the same way when there is a second threshold to consider and the second fraction is below 1 pixel. In the above description the first threshold and first fraction would have to be replaced with the second threshold and second fraction accordingly in order to describe the method in an embodiment with two thresholds.

With reference to FIG. 12, and FIG. 4 an electronic device 1200 operating according to embodiments of the method described earlier is disclosed. The electronic device 1200 comprising a screen 1004 operative to display a time bar 402 where a position of a slider 404 on said time bar is indicative of time of day. The electronic device 1200 also comprises, or co-operates with, a user interface, 1004, for control of the slider 404. The electronic device 1200 further comprises a processor 506 and a memory 508. Said memory 508 contains instructions executable by said processor 506 whereby said electronic device 1200 is operative to determine a value indicative of interaction between a user and a part of a user interface 1004 for control of the slider 404 and to change the time indicated by the slider 404, wherein the change of time Δt is in a non-linear relationship to the determined value.

Preferably the electronic device 1200 is operative to move the slider 404 on the time bar 402 by a distance corresponding to the change of time. For example, if one pixel corresponds to 10 minutes then change of time by 10 minutes results in moving the slider 404 by one pixel on the time bar 402. However, if the change of time is 5 minutes then the slider does not move, only the time indicated by the slider and displayed 406 on the screen 1004 is changed by 5 minutes. If the change of time is 25 minutes then the slider moves by two pixels because it is not possible to move an object on the screen by ½ pixel, but the time displayed 406 on the screen is updated according to the determined change of time Δt.

Embodiments of the invention described earlier teach how the value indicative of interaction between a user and a part of a user interface can be determined. Similarly examples of the non-linear relationship between the determined value and the change of time indicated by the slider on the time bar have been discussed.

In a preferred embodiment the electronic device 1200 comprises an accelerometer 1202 co-operating with the user interface. The electronic device 1200 determines the value indicative of interaction between a user and a part of a user interface by determining acceleration of a device with the user interface caused by tilting said device with the user interface.

In another preferred embodiment the electronic device 500 is operative to detect an object in contact with a touch-sensitive user interface 1004 for control of the slider 404 and to determine speed at which the object moves along the touch-sensitive user interface 1004. The determined speed is the value indicative of interaction between a user and a part of a user interface.

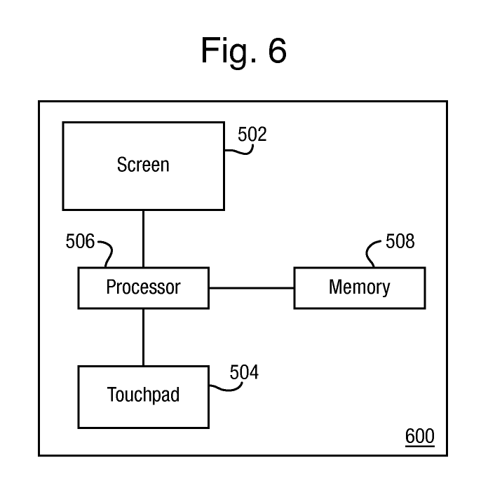

Although FIG. 12 and FIG. 5 illustrate a touchscreen 1004 the invention in its alternative embodiment may comprise a separate screen 502 and touchpad 504 as illustrated in FIG. 6, e.g. in a laptop.

With reference to FIG. 5, FIG. 6 and FIG. 10 an electronic device 500, 600 operating according to embodiments of the method described earlier is disclosed. The electronic device 500, 600 comprises a screen 502 operative to display a time bar 402 where a position of a slider 404 on said time bar is indicative of time of day. The electronic device 500, 600 also comprises a touch-sensitive user interface 504 for control of the slider 404. Of course, the touch-sensitive user interface 504 is operative to be used for control of other objects on the screen and functions of the electronic device, but as this is not the subject matter of the invention it will not be discussed in this document. The electronic device 500, 600 further comprises a processor 506 and a memory 508. The memory 508 contains instructions executable by said processor 506.

In operation said electronic device 500, 600 is operative to detect an object 1002 in contact with the touch-sensitive user interface 504 and determine speed at which the object 1002 moves along the touch-sensitive user interface 504. If the speed is at or below a first threshold then the electronic device is operative to move the slider 404 by a distance which is a first fraction of the distance travelled by the object 1002 along the touch-sensitive user interface 504.

The electronic devices 500 and 600 illustrated in FIG. 5 and FIG. 6 accordingly differ in that in the embodiment illustrated in FIG. 5 the electronic device comprises a touchscreen which combines the functions of a screen 502 and a touch-sensitive user interface 504. An alternative view of such a touchscreen 1004 is illustrated in FIG. 10. FIG. 6, in turn illustrates an alternative embodiment of the present invention in which the electronic device 600 comprises a screen 502 and a separate touchpad 504 operating as the touch-sensitive user interface.

In one embodiment if the speed is at or below a second threshold then said electronic device 500, 600 is operative to move the slider 404 by a distance which is a second fraction of the distance travelled by the object 1002 on the screen 502 or touchscreen 1004.

In one embodiment the contact between the object, e.g. the finger or stylus, and the touch-sensitive user interface, e.g. the touchscreen or touchpad, is achieved when the object touches the touch-sensitive user interface. In alternative embodiment the contact between the object and the touch-sensitive user interface is achieved when the object is detected in proximity of the touch-sensitive user interface. There are known, although not yet widely implemented, solutions that allow for detecting a finger in proximity of the screen of an electronic device and tracking movements of the object (gestures) in order to control objects displayed on the screen or to control the electronic device itself. These solutions are based on infrared sensors, or video cameras, to detect a user's finger close to the screen without actually touching the screen. The camera based solutions are capable of tracking movement of an object (gestures made by the user) even at a distance of few metres.

In a preferred embodiment the electronic device 500, 600 is operative, if the first fraction of the distance travelled by the object along the touch-sensitive user interface is below 1 pixel 304, to keep position of the slider 404 on the time bar 402 unchanged and to update the time of day 406 displayed on the screen by an amount of time corresponding to the first fraction of the distance travelled by the object along the touch-sensitive user interface. In this embodiment the user's finger moves 302 with a speed at or below the first threshold and if the distance travelled by the finger is short then the first fraction may be, in some situations, below 1 pixel. Of course it is not possible to move the slider by less than 1 pixel, but it is possible to calculate the change of time of day that corresponds to, for example, ½ pixel. In this embodiment the slider does not move, but the time of day displayed is updated by the value that corresponds to said ½ pixel. In another embodiment the electronic device 500, 600 is configured to operate in the same way when there is a second threshold to consider and the second fraction is below 1 pixel. In the above description of the electronic device 500, 600 the first threshold and first fraction would have to be replaced with the second threshold and second fraction accordingly in order to describe the operation of the electronic device 500, 600 in an embodiment with two thresholds.

In a preferred embodiment the time bar 402 displayed on the screen 502, 1004 of the electronic device 500, 600 is displayed as part of an Electronic Program Guide of a TV service.

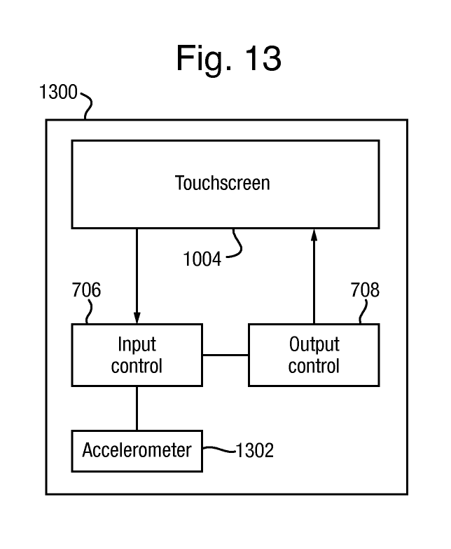

With reference to FIG. 13 and FIG. 4 an electronic device 1300 operating according to embodiments of the method described earlier is disclosed. The electronic device 1300 comprises a screen 1004 operative to display a time bar 402 where a position of a slider 404 on said time bar 402 is indicative of time of day. The electronic device also comprises a user interface 1004 for control of the slider 404. The electronic device 1300 further comprises an input control module 706 operative to determine a value indicative of interaction between a user and a part of a user interface for control of the slider and an output control module 708 operative to change the time indicated by the slider 404, wherein the change of time Δt is in a non-linear relationship to the determined value.

Preferably, the output control module 708 in the electronic device 1300 is operative to move the slider 404 on the time bar 402 by a distance corresponding to the change of time Δt as explained in the earlier described embodiments.

Embodiments of the invention described earlier teach how the value indicative of interaction between a user and a part of a user interface can be determined. Similarly examples of the non-linear relationship between the determined value and the change of time indicated by the slider on the time bar have been discussed.

In a preferred embodiment the electronic device 1300 comprises an accelerometer which co-operates with the user interface 1004. The input control module 706 is operative to determine the value by determining acceleration of a device with the user interface caused by tilting said device with the user interface.

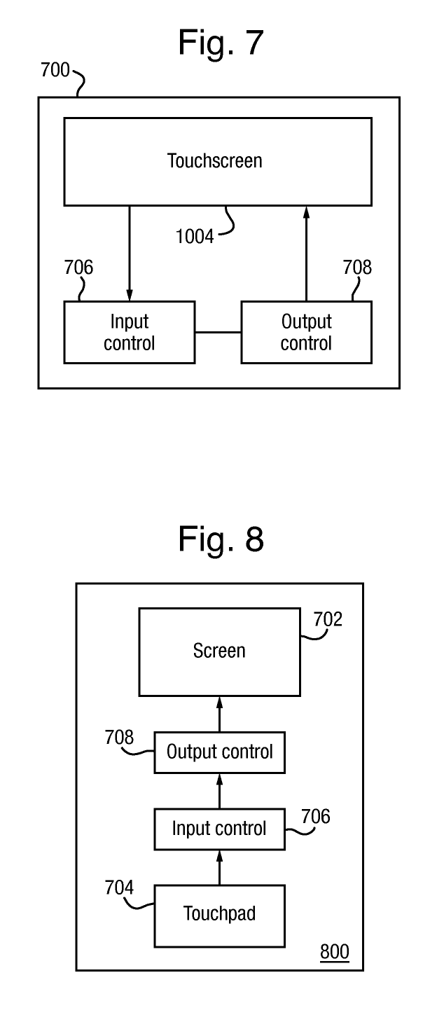

In another preferred embodiment of the electronic device 700, illustrated in FIG. 7, the input control module 706 is operative to detect an object in contact with a touch-sensitive user interface for control of the slider and to determine speed at which the object moves along the touch-sensitive user interface. The determined speed is the value indicative of interaction between a user and a part of a user interface.

Although FIG. 13 and FIG. 7 illustrate a touchscreen 1004 the invention in its alternative embodiment may comprise a separate screen 702 and touchpad 704 as illustrated in FIG. 8.

More alternative embodiments of an electronic device in accordance with the present invention are illustrated in FIG. 7 and FIG. 8. The electronic device 700, 800 comprises a screen 702 operative to display a time bar 402 where a position of a slider 404 on said time bar 402 is indicative of time of day. The electronic device 700, 800 also comprises a touch-sensitive user interface 704 for control of the slider 404. The electronic device 700, 800 further comprises and input control module 706 and an output control module 708. The input control module 706 is operative to detect an object 1002 in contact with the touch-sensitive user interface 704 and to determine speed at which the object 1002 moves along the touch-sensitive user interface 704. The output control module 708, in turn, is operative to move the slider 404 by a distance which is a first fraction of the distance travelled by the object 1002 along the touch-sensitive user interface 704 if the speed is at or below a first threshold.

The electronic device 700, 800 in one embodiment is operative to move the slider 404 by a distance which is a second fraction of the distance travelled by the object 1002 if the speed the object (e.g. finger or stylus) moves along the touch-sensitive unser interface is at or below a second threshold. In this embodiment of the electronic device 700, 800 the advantages are the same as in the earlier discussed embodiments with two thresholds.

Similarly to the embodiments of the electronic device 500, 600 discussed above the electronic device illustrated in FIG. 7 and FIG. 8 is configured for achieving contact between the object 1002 and the touch-sensitive user interface when the object 1002 touches the touch-sensitive user interface 704, or, in alternative embodiment, when the object 1002 is detected in proximity of the touch-sensitive user interface 704.

Preferably, the screen 702 and the touch-sensitive user interface 704 are combined to form a touchscreen as shown in FIG. 7. In an alternative embodiment the screen 702 is separate from a touchpad 704 operating as the touch-sensitive user interface 704.

In a preferred embodiment the electronic device 700, 800 is operative, if the first fraction of the distance travelled by the object along the touch-sensitive user interface is below 1 pixel 304, to keep position of the slider 404 on the time bar 402 unchanged and to update the time of day 406 displayed on the screen by an amount of time corresponding to the first fraction of the distance travelled by the object along the touch-sensitive user interface. In this embodiment the user finger moves 302 with a speed at or below the first threshold and if the distance travelled by the finger is short then the first fraction may be, in some situations, below 1 pixel. Of course it is not possible to move the slider by less than 1 pixel, but it is possible to calculate the change of time of day that corresponds to said first fraction, for example, ½ pixel. In this embodiment the slider does not move, but the time of day displayed, 406, is updated by the value that corresponds to said ½ pixel. In another embodiment the electronic device 700, 800 is configured to operate in the same way when there is a second threshold to consider and the second fraction is below 1 pixel. In the above description of the electronic device 700, 800 the first threshold and first fraction would have to be replaced with the second threshold and second fraction accordingly in order to describe the operation of the electronic device 700, 800 in an embodiment with two thresholds.

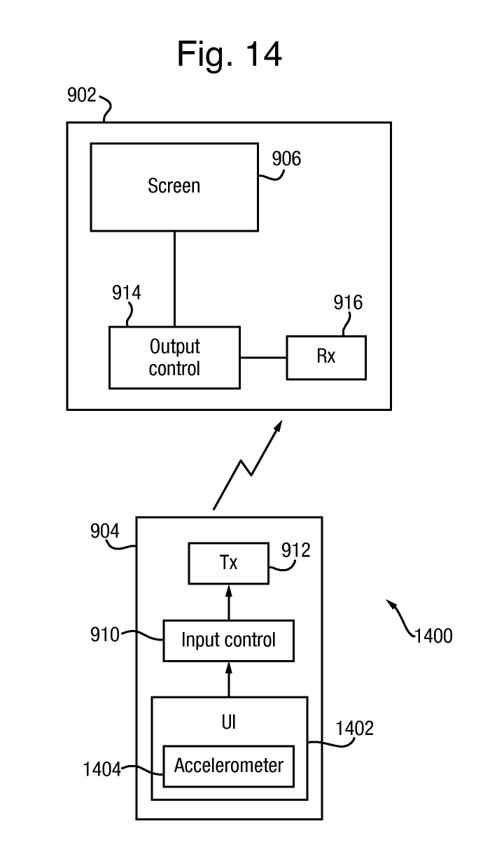

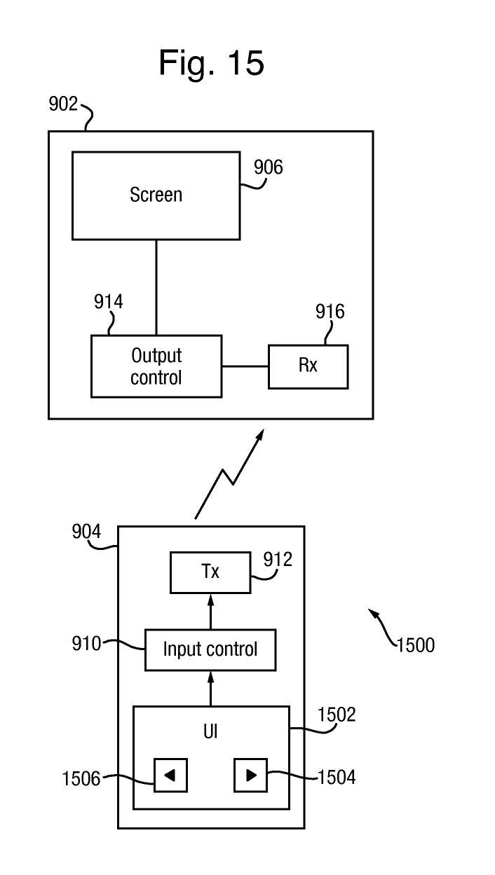

More embodiments of the present invention are illustrated in FIGS. 14 and 15. A TV set 1400, 1500, in these embodiments comprises a TV unit 902 and a remote control device 904. The TV unit 902 comprises a screen 906 operative to display a time bar 402 where a position of a slider 404 on said time bar 402 is indicative of time of day. The remote control device 904 is configured to control said TV unit 902. Said remote control device 904 comprises a user interface 1402, 1502 operative to control the slider 404 and an input control module 910 operative to determine a value indicative of interaction between a user and a part of the user interface for control of the slider 404. The remote control device 904 also comprises a wireless transmitter module 912 operative to transmit to the TV unit 902 the determined value as well as control commands as is well known in the art. The TV unit 902 further comprises a wireless receiver 916 operative to receive the determined value and control commands from the remote control device 904 and an output control module 914 operative to change the time indicated by the slider 404, wherein the change of time Δt is in a non-linear relationship to the determined value.

Preferably, the output control module 708 in the TV set 1400, 1500 is operative to move the slider 404 on the time bar 402 by a distance corresponding to the change of time Δt as explained in the earlier described embodiments.

Embodiments of the invention described earlier teach how the value indicative of interaction between a user and a part of a user interface can be determined. Similarly examples of the non-linear relationship between the determined value and the change of time indicated by the slider on the time bar have been discussed.

In a preferred embodiment the TV set 1400 comprises an accelerometer 1404 co-operating with the user interface 1402 and the input control module 910 is operative to determine the value indicative of interaction between a user and a part of the user interface for control of the slider by determining acceleration of the remote control device 604 caused by tilting said remote control device.

In an alternative embodiment the user interface 1502 is a well-known keyboard or keypad and the input control module 910 of the remote control device 904 is operative to determine the value indicative of interaction between a user and a part of the user interface for control of the slider by determining length of time the user presses a button 1504 or 1506 on the user interface 1502, said button 1504, 1506 controlling movements of the slider 404 on said time bar 402.

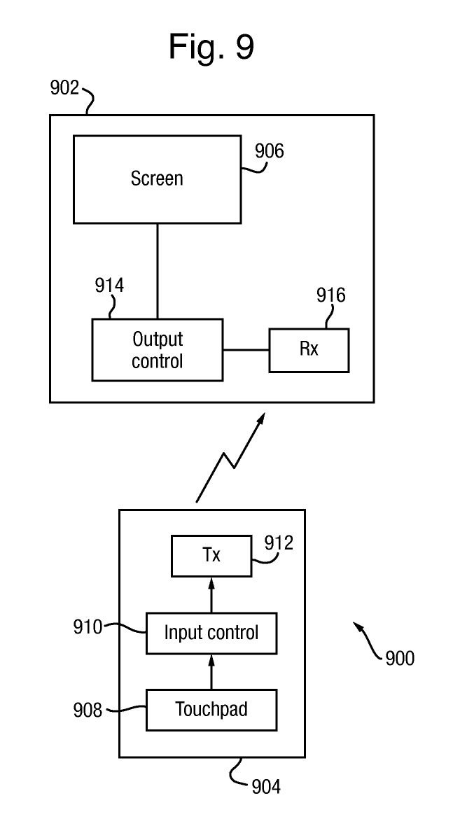

In yet another alternative embodiment said input control module 910 is operative to determine the value indicative of interaction between a user and a part of the user interface for control of the slider by detecting an object in contact with a touch-sensitive user interface 908 for control of the slider 404 and determining speed at which the object moves along the touch-sensitive user interface 908. The touch sensitive user interface is illustrated as a touchpad in FIG. 9.

FIG. 9 illustrates yet another embodiment of the present invention. In this embodiment a screen 906 on which a time bar 404 is displayed is part of a TV unit 902, which TV unit is remotely controlled by a remote control device 904. Together the TV unit 902 and the remote control device 904 form a TV set 900.

In a preferred embodiment the TV set 900 comprises a TV unit 902 and a remote control device 904. The TV unit 902 comprises a screen 906 operative to display a time bar 402 where a position of a slider 404 on said time bar 402 is indicative of time of day. The remote control device 904 is configured to control said TV unit 902. Said remote control device 904 comprises a touch-sensitive user interface 908, preferably in the form of a touch-pad, for control of the slider 404. Said remote control device 904 also comprises an input control module 910 operative to detect an object 1002 in contact with the touch-sensitive user interface 908 and to determine speed at which the object 1002 moves along the touch-sensitive user interface 908. Said remote control device 904 also comprises a wireless transmitter module 912 for transmitting to the TV unit 902 data indicative of position of the object 1002 with reference to the touch-sensitive user interface 908 and the determined speed. The wireless transmission between the remote control device 904 and the TV unit 902 may use infra-red (IR), Bluetooth, WiFi or other wireless transmission of the data and control commands to the TV unit 902.

The TV unit 902 further comprises a wireless receiver 916 for receiving the data indicative of position of the object 1002 with reference to the touch-sensitive user interface 908 and the determined speed from the remote control device 904 and providing this information to an output control module 914. The output control module 914 is operative to move the slider 404 by a distance which is a first fraction of the distance travelled by the object 1002 along the touch-sensitive user interface 908 if the speed is at or below a first threshold.

The main difference between the embodiment illustrated in FIG. 9 and embodiments illustrated in FIGS. 5-8 is that the device shown in FIG. 9 comprises two physically separate units: a TV unit 902 for displaying content delivered by a TV service and a remote control device 904 for controlling the TV unit 902.

Similarly to the previous embodiments if the speed is at or below a second threshold then then the TV set 900 is operative to move the slider 404 by a distance which is a second fraction of the distance travelled by the object 1002 along the touchpad 908. Also the remaining embodiments related to achieving contact between the object and the touch sensitive user interface, displaying position of the slider on the screen as time of day and operating in situations when the first fraction or second fraction of the distance travelled by the object along the touch-sensitive user interface is below one pixel are similar or identical to corresponding embodiments of the electronic devices illustrated in FIGS. 5-8 and described above.

1. A method of navigating on a time bar displayed on a screen of an electronic device where a position of a slider on said time bar is indicative of time of day, the method comprising:
determining a value indicative of interaction between a user and a part of a user interface for control of the slider;
changing the time indicated by the slider, wherein the change of time is in a non-linear relationship to the determined value.

2. The method according to claim 1 comprising moving the slider on the time bar by a distance corresponding to the change of time.

3. The method according to claim 1, wherein the step of determining comprises determining acceleration of a device with the user interface caused by tilting said device with the user interface.

4. The method according to claim 1, wherein the step of determining comprises determining length of time the user presses a button controlling the slider on a device with the user interface.

5. The method according to claim 1, wherein the step of determining comprises:
detecting an object in contact with a touch-sensitive user interface for control of the slider;
determining speed at which the object moves along the touch-sensitive user interface.

6. The method according to claim 1 comprising:
detecting an object in contact with a touch-sensitive user interface for control of the slider;
determining speed at which the object moves along the touch-sensitive user interface and if the speed is at or below a first threshold then
moving the slider by a distance which is a first fraction of the distance travelled by the object along the touch-sensitive user interface.

7. The method according to claim 6 wherein if the speed is at or below a second threshold then moving the slider by a distance which is a second fraction of the distance travelled by the object.

8-12. (canceled)

13. An electronic device comprising a screen operative to display a time bar where a position of a slider on said time bar is indicative of time of day, a user interface for control of the slider; the electronic device further comprises a processor and a memory, said memory containing instructions executable by said processor whereby said electronic device is operative to:
determine a value indicative of interaction between a user and a part of a user interface for control of the slider;
change the time indicated by the slider, wherein the change of time is in a non-linear relationship to the determined value.

14. The electronic device according to claim 13 operative to move the slider on the time bar by a distance corresponding to the change of time.

15-16. (canceled)

17. The electronic device according to claim 13, wherein the user interface is touch sensitive and said electronic device is operative to:
detect an object in contact with the touch-sensitive user interface;
determine speed at which the object moves along the touch-sensitive user interface and if the speed is at or below a first threshold then
move the slider by a distance which is a first fraction of the distance travelled by the object along the touch-sensitive user interface.

18. The electronic device according to claim 17 wherein if the speed is at or below a second threshold then said electronic device is operative to move the slider by a distance which is a second fraction of the distance travelled by the object.

19-20. (canceled)

21. The electronic device according to claim 17, wherein the electronic device is operative to display on said screen the position of the slider on said time bar as time of day.

22. (canceled)

23. The electronic device according to claim 17, wherein the screen and the touch-sensitive user interface are parts of a touchscreen.

24. The electronic device according to claim 17, wherein the time bar is displayed as part of an Electronic Program Guide of a TV service.

25-35. (canceled)

36. A TV set comprising a TV unit and a remote control device, the TV unit comprising a screen operative to display a time bar where a position of a slider on said time bar is indicative of time of day, the remote control device is configured to control said TV unit; said remote control device comprising:
a user interface operative to control the slider;
an input control module operative to determine a value indicative of interaction between a user and a part of the user interface for control of the slider; and
a wireless transmitter module operative to transmit to the TV unit the determined value;
wherein the TV unit further comprises:
a wireless receiver operative to receive the determined value from the remote control device; and
an output control module operative to change the time indicated by the slider, wherein the No. Not Yet Assigned Page 7 change of time is in a non-linear relationship to the determined value.

37. The TV set according to claim 36, wherein the output control module is operative to move the slider on the time bar by a distance corresponding to the change of time.

38. The TV set according to claim 36 further comprising an accelerometer co-operating with the user interface, wherein the input control module is operative to determine the value by determining acceleration of the remote control device caused by tilting said remote control device.

39. The TV set according to claim 36, wherein the input control module is operative to determine the value by determining length of time the user presses a button on the user interface, said button controlling the slider.

40. The TV set according to claim 36, wherein said input control module is operative to determine the value by:
detecting an object in contact with a touch-sensitive user interface for control of the slider; and
determining speed at which the object moves along the touch-sensitive user interface.

41. The TV set according to claim 36, wherein the user interface is touch sensitive and the input control module is operative to detect an object in contact with the touch-sensitive user interface and to determine speed at which the object moves along the touch-sensitive user interface; wherein the wireless transmitter module is operative to transmit to the TV unit the determined speed; the wireless receiver is operative to receive the determined speed from the remote control device; wherein the output control module is operative to move the slider by a distance which is a first fraction of the distance travelled by the object along the touch-sensitive user interface if the speed is at or below a first threshold.

42-46. (canceled)
